(19) United States
(12) Patent Application Publication
(10) Pub. No.: US 2004/0046329 A1
(43) Pub. Date: Mar. 11, 2004

(54) Sealing ring

(76) Inventor: Koen Pieters, Mechelen (BE)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/641,892

(22) Filed: Aug. 14, 2003

Related U.S. Application Data
(60) Provisional application No. 60/408,426, filed on Sep. 5, 2002.

(51) Int. Cl. F16J 9/12

(52) U.S. Cl. 277/496

(57) ABSTRACT

A synthetic annular sealing ring is provided. The ring has a break therein with first and second complementary ends defining opposite sides of the break. An internally directed annular section of the ring has a first and second internal tongues protruding from the ring ends, and it has first and second internal slots formed in the internally directed section of the ring ends. The first internal tongue is aligned to fit into the second internal slot, and the second internal tongue is aligned to fit into said first internal slot. An externally directed annular section of the ring has a first and second external tongues abutting the second and first internal tongues and protruding from the ring ends, and it has first second external slots formed therein at the ring ends and abutting the second and first internal slots. The first external tongue is aligned to fit into the second external slot, and the second external tongue is aligned to fit into the first external slot. The first and second internal tongues are each longer than both of the first and second external tongues in the annular direction of the ring.

This application claims the benefit of U.S. Provisional Application No. 60/408,426 filed Sep. 5, 2002 which is incorporated by reference herein for all purposes as if fuly set forth.

### BACKGROUND OF THE INVENTION

1. Field of the Invention

This invention relates to a sealing ring, and more particularly to an expandable sealing ring made of a synthetic material.

2. Description of the Related Art

Sealing rings are used in mechanical devices for creating a seal between a shaft or rod and a bore, as for example in compressors, automatic transmissions, and power steering devices. A seal ring is generally of an open annular shape and is mounted on a circumferential groove of a shaft or rod that is situated within a cylindrical housing. The function of the seal ring is normally to control the leakage of fluid from one side of the ring to the other side while allowing the shaft or rod to turn or pulsate within the cylindrical housing.

Seal rings have been made with joints that allow the rings to expand or contract with expansion or contraction of the shaft or rod on which the seal ring is mounted, as occurs for example during thermal expansion or contraction of the shaft. The joints of such expandable seal rings have been made with various geometrical configurations according to which the open gap between ends of the ring is minimized when operating in the housing. Existing joint arrangements for seal rings include butt joints, scarf joints and step joints. International patent publication no. WO 96/21116 discloses a plastic sealing ring with a separating cut configured as a step-shaped overlap in which the mutually overlapping ring ends lie against each other along a sliding surface. Such overlapping sealing ring ends result in rings with relatively constant gaps that, for a given temperature range, are more or less independent of the coefficients of thermal expansion of the shaft, the housing and the sealing ring.

When existing expandable sealing rings expand, the overlapping ends tend to bow outward which causes the ends of the ring to press against the bore. This results in uneven wear on the rings, making more frequent replacement of the rings necessary. This increases down time as well as maintenance and material costs. Accordingly, there is a need for an expandable sealing ring with overlapping ends that maintains a round shape upon expansion and contraction. There is a further need for such expandable sealing rings that do not bow out upon expansion or contraction, especially where the ring is made of a synthetic polymer material such as plastic.

### SUMMARY OF THE INVENTION

The present invention relates to a synthetic annular sealing ring. The ring has a break therein with first and second complementary ends defining opposite sides of the break. An internally directed annular section of the ring has a first internal tongue protruding from the first ring end and a first internal slot formed in the internally directed section at the first ring end. The internally directed annular section has a second internal tongue protruding from the second ring end and a second internal slot formed in the internally directed section at the second ring end. The first internal tongue is aligned to fit into the second internal slot, and the second internal tongue is aligned to fit into said first internal slot. An externally directed annular section of the ring has a first external tongue abutting the first internal tongue and protruding from the first ring end, and a first external slot formed in the externally directed annular section at the first ring end and abutting the first internal slot. The externally directed annular section also has a second external tongue abutting said second internal tongue and protruding from the second ring end, and a second external slot formed in the externally directed annular section at the second ring end and abutting the second internal slot. The first external tongue is aligned to fit into the second external slot, and the second external tongue is aligned to fit into the first external slot. The first and second internal tongues are each longer than both of the first and second external tongues in the annular direction of the ring.

### BRIEF DESCRIPTION OF THE DRAWINGS

FIG. 1 is a perspective view of the sealing ring of the invention as viewed from a point in front of and above the sealing ring;

FIG. 2 is a perspective view of the sealing ring shown in FIG. 1 as viewed from a point in front of and below the sealing ring;

FIGS. 3A-3C are each a detailed perspective view of the locking portion of the sealing ring shown in FIGS. 1 and 2, as viewed from the bottom of the ring.

### DETAILED DESCRIPTION OF THE INVENTION

A sealing ring according to the present invention is illustrated in FIG. 1. The sealing ring 10 is shown mounted on a cylinder C. The sealing ring 10 is preferably comprised of a synthetic material such as a polymer resin. Sealing ring 10 has an internally directed annular section 12 surrounded by an externally directed annular section 14. The sealing ring 10 has a break 16 defined by a first end 18 and a second end 20. According to the preferred embodiment of the invention, ring ends 18 and 20 are generally complementary ends that define opposite sides of the break 16.

In the embodiment of the invention shown in FIGS. 1-3, the internally directed annular section 12 has a first internal tongue 22 protruding from the first ring end 18 and a first internal slot 24 formed in said internally directed section at said first ring end. The internally directed annular section also has a second internal tongue 26 protruding from the second ring end 20 and a second internal slot 28 formed in the internally directed section at said second ring end. The first internal tongue 22 is aligned to fit into said second internal slot 28, and the second internal tongue 26 is aligned to fit into said first internal slot 24.

In the embodiment of the invention shown in FIGS. 1-3, the externally directed annular section 14 of the sealing ring 10 has a first external tongue 30 abutting said first internal tongue 22 and protruding from said first ring end 18, a first external slot 32 formed in the externally directed annular section 14 at the first ring end 18 and abutting the first internal slot 24. A second external tongue 34 abuts the second internal tongue 26 and protrudes from said second ring end 20. A second external slot 36 is formed in the externally directed annular section 14 at the second ring end 20 and abutting the second internal slot 28. The first external tongue 30 is aligned to fit into the second external slot 36, and the second external tongue 34 is aligned to fit into said first external slot 32.

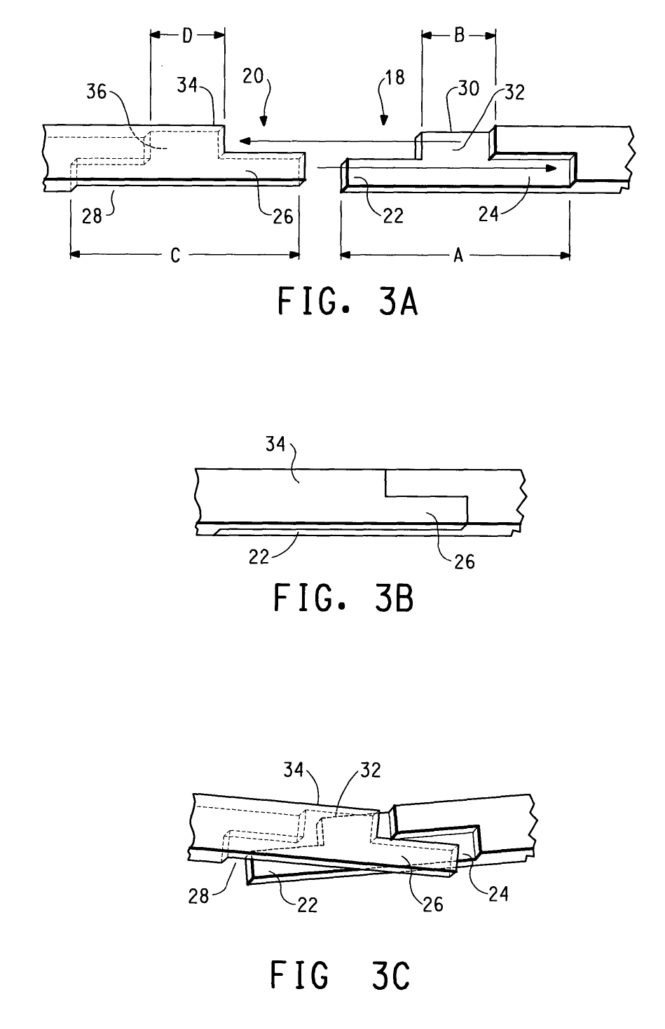

In accordance with the invention, the first and second internal tongues are each longer than both of said first and second external tongues in the annular direction of the ring. In the embodiment of the invention shown in FIGS. 1-3, the first and second internal tongues 22 and 26 are each longer than both of said first and second external tongues 30 and 34 in the annular direction of the ring 10. As used herein, the length of a tongue is the length that the thinner portion of the tongue extends in the annular direction from where thinner portion of the tongue begins. As illustrated in FIG. 3A, the length of the first internal tongue 22 is the length “A” and the length of the second internal tongue 26 is the length “C”. Similarly, the length of the first external tongue 30 is the length “B” shown in FIG. 3A, and the length of the second external tongue 34 is the length “D” shown in FIG. 3A.

According to a preferred embodiment of the invention, the first internal tongue and the second internal slot are complementary, and the second internal tongue and said first internal slot are complementary. In the embodiment of the invention shown in FIGS. 1-3, the first internal tongue 22 and the second internal slot 28 are complementary, and the second internal tongue 26 and said first internal slot 24 are complementary. It is further preferred that the first external tongue and the second external slot be complementary, and that the second external tongue and the first external slot be complementary. In the embodiment of the invention shown in FIGS. 1-3, the first external tongue 30 and the second external slot 36 are complementary, and the second external tongue 34 and the first external slot 32 are complementary. According to a preferred embodiment of the invention, the first internal tongue forms a surface of said first internal slot, and the second internal tongue forms a surface of said second internal slot. In the embodiment of the invention shown in FIGS. 1-3, the first internal tongue 22 forms a surface of said first internal slot 24, and the second internal tongue 26 forms a surface of said second internal slot 28. In a similar manner, the first external tongue 30 forms a surface of said first external slot 32, and the second external tongue 34 forms a surface of said second external slot 36.

According to one embodiment of the invention, the first and second internal tongues are each at least 20% longer than both of said first and second external tongues in the annular direction of the ring. The first and second internal tongues may be more than 50% longer than both of said first and second external tongues in the annular direction of the ring. In the embodiment of the invention shown in FIGS. 1-3, the first and second internal tongues are about three times as long as said first and second external tongues in the annular direction of the ring.

Preferably, the first and second internal tongues have substantially the same dimensions, and the first and second external tongues have substantially the same dimensions. In the embodiment of the invention shown in FIGS. 1-3, the first and second internal tongues 22 and 26 are of substantially the same length, width and height, and the first and second external tongues 30 and 34 are of substantially the same length, width and height. Likewise, the second internal slot 28 preferably has a length, width and height that are just a fraction larger than the complementary first internal tongue 22, and the first internal slot 24 preferably has a length, width and height that are just a fraction larger than the complementary second internal tongue 26. Similarly, the second external slot 36 preferably has a length, width and height that are just a fraction larger than the complementary first external tongue 30, and the first external slot 32 preferably has a length, width and height that are just a fraction larger than the complementary second external tongue 34. As used herein, the length of a slot is the length that the open space of the slot extends in the annular direction from where the open slot begins. As illustrated in FIG. 3A, the length of the first internal slot 24 is the length “A” and the length of the second internal slot 28 is the length “C”. Similarly, the length of the first external slot 32 is the length “B” shown in FIG. 3A, and the length of the second external slot 36 is the length “D” shown in FIG. 3A.

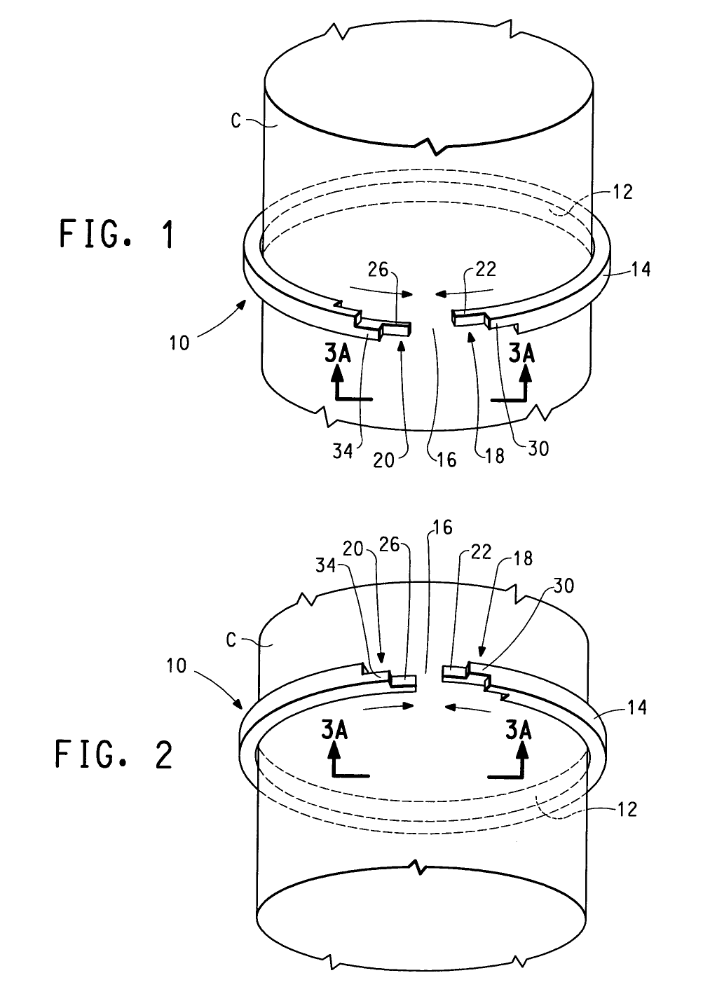

According to a preferred embodiment of the invention, the first and second internal tongues, the first and second internal slots, the first and second external tongues, and the first and second external slots each have substantially rectangular cross sections. More preferably, the first and second internal tongues, the first and second internal slots, the first and second external tongues, and the first and second external slots each have square cross sections as shown in FIGS. 1-3. It is further preferred that the synthetic annular ring have an internally directed surface that is substantially concentric with an externally directed surface of the synthetic annular ring. In the embodiment of the invention shown in FIGS. 1 and 2, the internal surface of the internal annular section 12 is concentric with the external surface of the external annular section 14. It is further preferred that the sealing ring have a substantially rectangular cross section, and still further preferred that the sealing ring have a square cross section.

According to the preferred embodiment of the invention, the sealing ring is comprised of a high performance polymer. It is further preferred that the sealing ring is comprised of a synthetic polymer that is resistant to high temperature, has a high melting point, has high compressive strength, and is not brittle. It is further preferred that the sealing ring be comprised of a material that has a low coefficient of thermal expansion and a low coefficient of friction. Preferred polymers include one or more polymers selected from the group of polyimide, Poly-ether-etherketon (“PEEK”), Poly-amide-imide (“PAI”), poly-ether-keton-keton (“PEKK”), Poly-ether-keton (“PEK”), Thermoplastic-polyimide (“TPI”), fluoropolymers such as polytetrafluorethylene (“PTFE”) or perfluoroalkoxy (“PFA”), polyetherimide (“PEI”), polyphenylene sulfide (“PPS”), polysulfones, polyether sulfones (“PES”), and liquid crystal polymer (“LCP”). More preferably, the sealing ring is comprised of a polyimide such as a Vespel® thermoplastic material sold by E.I. du Pont de Nemours and Company of Wilmington, Del. Preferably, the sealing ring of the invention is produced by injection molding, but it may alternatively be produced by other know methods.

The sealing ring of the invention that has been described above has the advantage that the two seal ring ends lock with each other in a manner that allows the ring to maintain the preferred ideal circular shape when the two ends of the ring are locked and overlapped so as to achieve the sealing function. With the sealing ring of the invention, the ideal circular shape is maintained independent of radial loading.

We claim:

1. A sealing ring comprising:
a synthetic annular ring having an internally directed annular section surrounded by an externally directed annular section, said ring having a break therein and first and second complementary ends defining opposite sides of the break,
said internally directed annular section having a first internal tongue protruding from said first ring end and a first internal slot formed in said internally directed section at said first ring end, and said internally directed annular section having a second internal tongue protruding from said second ring end and a second internal slot formed in the internally directed section at said second ring end, said first internal tongue being aligned to fit into said second internal slot, and said second internal tongue being aligned to fit into said first internal slot;
said externally directed annular section having a first external tongue abutting said first internal tongue and protruding from said first ring end, a first external slot formed in said externally directed annular section at said first ring end and abutting said first internal slot, a second external tongue abutting said second internal tongue and protruding from said second ring end, and a second external slot formed in the externally directed annular section at said second ring end and abutting said second internal slot, said first external tongue being aligned to fit into said second external slot, said second external tongue being aligned to fit into said first external slot;
wherein said first and second internal tongues are each longer than both of said first and second external tongues in the annular direction of the ring.

2. The sealing ring of claim 1 wherein said first internal tongue and said second internal slot are complementary, and wherein said second internal tongue and said first internal slot are complementary.

3. The sealing ring of claim 2 wherein said first external tongue and said second external slot are complementary, and wherein said second external tongue and said first external slot are complementary.

4. The sealing ring of claim 3 wherein said first and second internal tongues are each at least 20% longer than both of said first and second external tongues in the annular direction of the ring.

5. The sealing ring of claim 3 wherein said first and second internal tongues have substantially the same dimensions, and wherein said first and second external tongues have substantially the same dimensions.

6. The sealing ring of claim 5 wherein said first and second internal tongues are each at least 50% longer than both of said first and second external tongues in the annular direction of the ring.

7. The sealing ring of claim 2 wherein said first internal tongue forms a surface of said first internal slot, and wherein said second internal tongue forms a surface of said second internal slot.

8. The sealing ring of claim 2 wherein said first and second internal tongues, said first and second internal slots, said first and second external tongues, and said first and second external slots each have substantially rectangular cross sections.

9. The sealing ring of claim 8 wherein said first and second internal tongues, said first and second internal slots, said first and second external tongues, and said first and second external slots each have square cross sections.

10. The sealing ring of claim 8 wherein the said synthetic annular ring has an internally directed surface that is substantially concentric with an externally directed surface of the synthetic annular ring.

11. The sealing ring of claim 10 wherein the sealing ring has a substantially rectangular cross section.

12. The sealing ring of claim 11 wherein the sealing ring has a square cross section.

13. The sealing ring of claim 1 wherein the ring is comprised polymer material.

14. The sealing ring of claim 13 wherein the polymer material is one or more polymers selected from the group of polyimide, PEEK, PAI, PEKK, PEK, TPI, fluoropolymer, PEI, PPS, polysulfones, PES and LCP polymers.

15. The sealing ring of claim 14 where the fluoropolymer is from the group of PTFE and PFA.

16. The sealing ring of claim 13 wherein the ring consists essentially of polyimide polymer.
